(19) United States
(12) Patent Application Publication
(10) Pub. No.: US 2008/0268409 A1
(43) Pub. Date: Oct. 30, 2008

(54) Bible Field Enhancer

(76) Inventor: George Y. Cheng, Wilmington, CA (US)

Correspondence Address: PARK LAW FIRM, 3255 WILSHIRE BLVD, SUITE 1110, LOS ANGELES, CA, 90010, US

(21) Appl. No.: 11/739,451

(22) Filed: Apr. 24, 2007

(51) Int. Cl. G09B 19/00

(52) U.S. Cl. 434/245

(57) ABSTRACT

A bible field enhancer includes a receiver cone that is hollow, and the apex of which is positioned near a bible. The bible is open in the middle and closed over the top, wherein the apex of the receiver cone is projected about ⅔ way in the middle of the bible. The enhancer also includes a bible jacket holder that holds a partially opened bible, and is attached along the receiver cone. The receiver cone and the bible jacket holder may be provided as small units that are assembled to make a large cone.

### BACKGROUND OF THE INVENTION

The present invention relates to a bible field enhancer. More particularly, the invention relates to a bible field enhancer that is effective in treating and controlling patient's pain.

The Dermatron is an analytical instrument (EAV: electroacupuncture According to Voll) developed in the 1950's by Dr. Voll in Germany to analyze the energy state of health of Chinese acupuncture meridians which reflect the energetic state of health of various body systems, i.e., heart, small intestines, endocrine, lung etc. A skin probe is used to measure the electrical skin resistances on a meter. This meter is scaled from zero to 100, where 50 represents a normal healthy state. 51-100 represents, progressive inflammatory disease states, and 0-49 represents progressive degeneration states. Plain and infection manifestations are in the inflammatory zone and cancer in the degenerative zone (Refer to FIG. 7).

The Dermatron also has the capability to determine the therapeutic of harmful effects of medicine, vitamins, herbs, food, etc. on any meridian when it is placed in the electrical probe circuitry. Even the benefits of prayer can be determined. It has often been found for the average devout Christian that their prayers for mild illness help for about one minute when measured on the Dermatron. True healing will show persistent reading of 50 indefinitely.

About five years ago, the inventor found that reading a popular verse (John 3:16) transiently improved the meter reading for about 30 seconds. Testing several conditions such as reading a Xerox copy, reading with eyes closed, reading in silence, reading at a distance away from the Bible had no benefits. Maps, pictures, commentaries weaken the benefit. It was concluded that the Bible has a field phenomenon or characteristic. Because the body meridians represent bio-field characteristics on the skin, the bible field also has a therapeutic bio-field body. This human property could be reflective of an undiscovered spiritual presence of God in the Bible text. The problem is that this Bible field created by the word text of the Bible is so weak that it has remained undetectable, elusive and of no practical value. But if it could be amplified thousands of time, it could be a constant, predictable, easily administrable, free and inexhaustible source of healing power to help impact the crushing cost of chronic care throughout the world. The divine presence of God is not just limited only to pain but potentially to all diseases.

The Bible Field Enhancer was invented through extensive research and development. It amplified the bible field to a level where you do not have to read any passages in the Bible, just stand in front of it for about 30 minutes. Nearly all patients have felt relief immediately and have been nearly pain free for 1-2 weeks at least with one treatment. The Dermatron also reflects these improvements.

### SUMMARY OF THE INVENTION

The present invention contrives to solve a problem that has not been addressed by the prior art.

An object of the invention is to provide a bible field enhancer that enhances a bible field.

Another object of the invention is to provide a bible field enhancer that is effective in treating patient's pain.

To achieve the above objects, the present invention provides a bible field enhancer that enhances a bible field of a bible. The bible field enhancer operates a receiver that is adapted to receive the bible field. The receiver includes a first hollow cone and the cone has an outer surface, an inner surface, an apex closed end and a base open end. The apex open end of the cone is adapted to be located close to the bible.

The cone is made of titanium and has a bible jacket holder attached to the outer surface. The bible jacket holder holds bibles incased with a gold leaf lined copper foil sheet.

The cone consist of an apex cone segment closed at the tip on one end and open at the base measuring 5¾ inches in diameter at the other end. This apex segment measures 41 inches in length.

The receiver may have a second hollow middle cone with an outer surface, an inner surface, a smaller open end and a larger base open end, and the smaller open end of the second cone surrounds the base open end of the first cone. The second measures 28 inches in length and measures from about 6 inches to 10 inches in diameter at the smaller open end and the base open end respectively. The receiver may have a third hollow or distal cone segment with an outer surface and an inner surface, a smaller open end, and a larger base open end. The smaller open end of the third cone surrounds the base open end of the second cone segment. The third cone segment measures 48 inches in length and measures from about 10¾ inches to 14½ inches in diameter at the smaller open end and base open end, respectively.

The bible field enhancer further includes a bible pedestal that supports the bible in unfolded state and the apex closed end of the cone is close to the bible pedestal.

Plain bible for the bible field enhancer has the best result, and bible with commentation has interference. Judeo-Christian bible is the best in the original text. Hebrew old testament and new testament version are the best, or alternatively, the old and new testaments written completely in those of the King James Version, in original text, or any accurate translation into any language.

Although the present invention is briefly summarized, the fuller understanding of the invention can be obtained by the following drawings, detailed description, and appended claims.

### BRIEF DESCRIPTION OF THE DRAWINGS

These and other features, aspects and advantages of the present invention will become better understood with reference to the accompanying drawings, wherein:

FIG. 1 is a perspective view showing a bible field enhancer according to the present invention;

FIG. 2 is a top view of the bible field enhancer;

FIG. 3 is a rear elevation view of a receiver cone;

FIG. 4 is a front elevation view of the receiver cone;

FIG. 5 is an elevation view of a bible jacket holder;

FIG. 6 is a perspective view showing the bible field enhancer with the apex of the receiver cone is covered with sheets of a bible; and

FIG. 7 is a perspective view of a meter that shows electrical skin resistance.

### DETAILED DESCRIPTION OF THE INVENTION

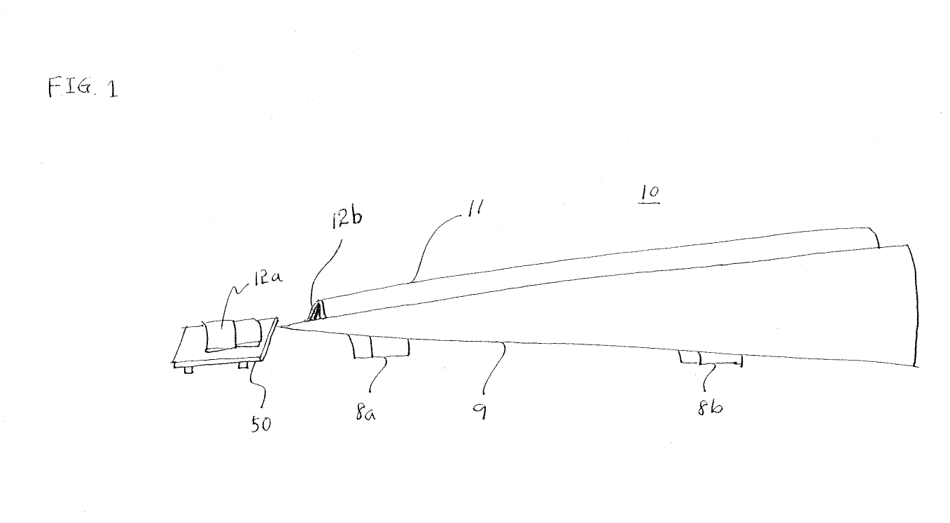

FIG. 1 shows a bible field enhancer 10 according to the present invention. The bible field enhancer 10 includes a hollow receiver cone 9 and a bible jacket holder 11 that is attached along the receiver cone 9. The bible field enhancer 10 enhances the bible field of a bible 12a that is placed on a bible pedestal 50, and a plurality of bibles 12b that are enclosed in the bible jacket holder 11. The receiver cone 9 is supported by pedestals 8a and 8b. While there is no ideal size or minimum size required for the receiver cone 9, preferably the height to base diameter ratio is 7 to 1 or more. The larger the receiver cone, the stronger the bible field by allowing more bibles attached to it.

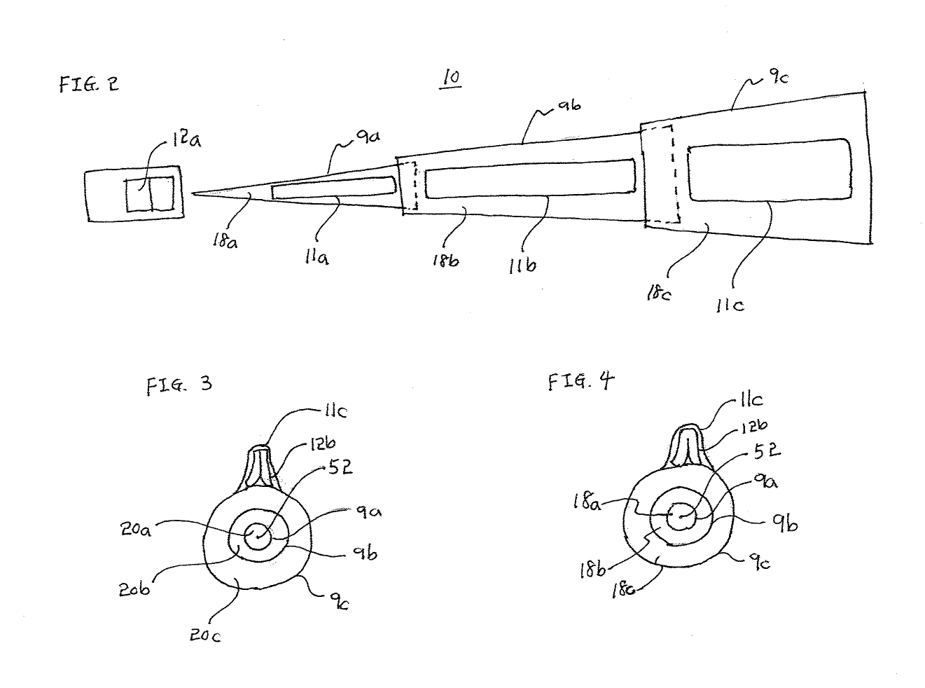

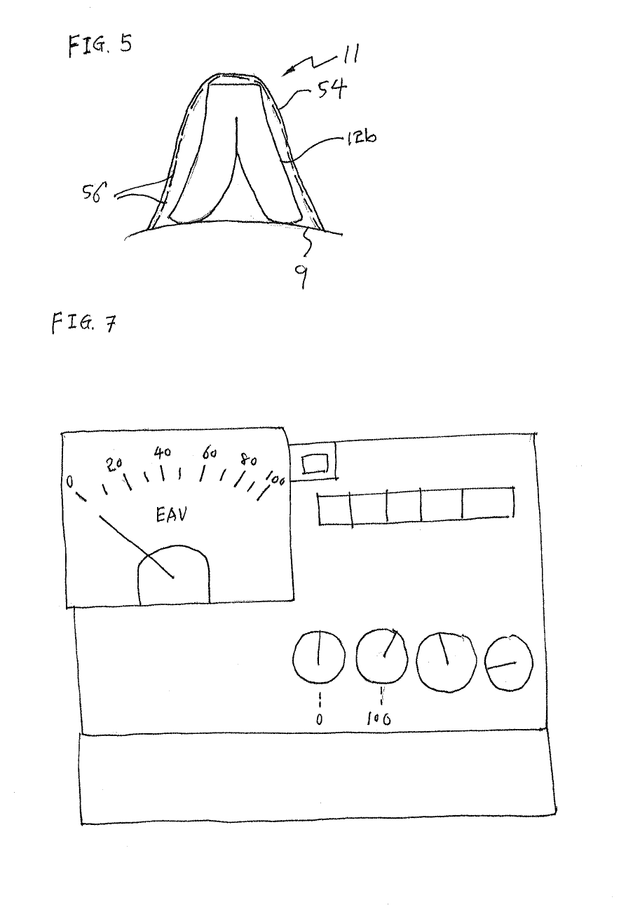

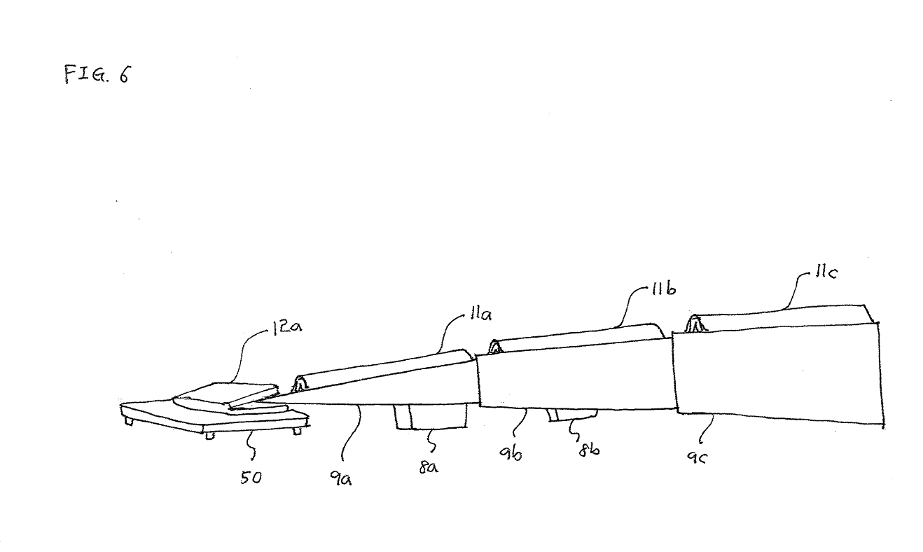

FIG. 2 shows that the receiver cone 9 are provided as an assembly of three cone segments 9a, 9b, and 9c, and the bible jacket holder 11 are provided as three separate jacket holders 11a, 11b, and 11c that are attached to the cone segments 9a, 9b and 9c, respectively. The cone segments 9a, 9b and 9c are made of commercial grade 2-quality titanium, and have 0.02 inch thickness. Black duct tapes and Velcro patches are used to stabilize the cone segments. Tight tolerances between the dimensions of the cone segments are not critical.

Referring to FIGS. 3 and 4, the cone segment has an apex 52 that is a closed and sharp point. The cone segments 9a, 9b, 9c includes outer surfaces 18a, 18b, 18c, and inner surfaces 20a, 20b, 20c, respectively. The cone segment 9a has 41″ length, and diameter from 0 to 5¾ inches. The cone segment 9b has 28″ length, and diameter from 6 to 10 inches. The cone segment 9c has 48″ length and diameter from 10¾-14¼ inches. The middle cone segment 9b overlaps with the apex cone segment 9a and the distal cone segment 9c, and the overall assembled length is about 115 inches. Distilled water may be filled inside the receiver cone 9. The effect with distilled water in the cone chamber is superior to ambient air.

Referring to FIG. 5, the bible 12b includes a Gideon bible with covers removed. Each of the jacket holders 11a, 11b and 11c includes a copper foil panel 54, and a plurality of gold leaves 56 that are lined up and layered over the copper foil panel 54. The gold leaf 56, or gold leaf paper is rectangular has a size of 3½ by 3½ inches. The copper foil panel 54 is precut to match the length of each of the cone segments and is wide enough to fold over the back, binding and front of the bible 12b. The copper foil panel has 0.20 inch thickness.

The bible 12b is closed about 75%-80% with approximately 20%-25% open at the middle, page 647 of Gideon bible. The exposed portion is open at about 60-90 degrees angle to lay over the outer surface of the cone segment. The bibles 12b directly contact the outer surface 18a, 18b, 18c of the cone segments 9a, 9b, 9c. Black duct tape and Velcro patches are used to hold the bible 12b in this shape win the jacket holder 11a, 11b, 11c. The bibles 12b in the jacket holders are aligned so that they have the same orientation. The open ends of the bible jacket holders are aligned over the surface of the cone segments 9a, 9b, 9c evenly. The jacket holders 11a, 11b, 11c can be in any rotated position with respect to the cone segments 9a, 9b, 9c. In FIGS. 2 and 6, they are pointed upward. The jacket holders may lay sideways on a table for stability.

FIG. 6 shows that the detached open bible 12a is sits on the bible pedestal 50 and is open in the middle. The apex 52 of the cone segment 9a is projected about ⅔ way in the middle of the bible 12a. The bible 12a is closed over the top.

In use of the bible field enhancer 10, people expose the part of their body in pain directly in front of the largest cone segment 9c. The Judeo-Christian bible with the old and new testaments texts written completely in Hebrew is the best. However, most English versions though not as potent are still quite effective. Maps, red print and other commendations cause interference with the Bible field.

The following are a few case histories of patients that have benefited from exposure to the bible field enhancer after it was completed. Patients would expose the area of pain at a distance of 1-2 feet in front of the base open end of the cone for 20-30 minutes. They were not encouraged to pray or read the Bible.

### EXAMPLE 1

A 65 years old female with rheumatism and early arthritis of both hands for 2 years complain of pain especially when she flexed her hands and finger. Even before finishing exposure to the Bible field she noticed improvement in the pain. After the treatment the pain continued to improve and was nearly gone. Checking with her in a few days the improvement was still significant and after 3 weeks, there still was come benefit.

### EXAMPLE 2

A 60 years old male with borderline hypertension for 2 years has persistent readings of 140/90. He was not taking any hypertensive medication. After exposure to the bible field, his blood pressure a few hours later read 130/80. Checking the pressure the next day also remained the same, 130/80. One month later his blood pressure read 130/88.

### EXAMPLE 3

A 42 years old female had a problem of amenorrhea for a few years. Missing her period made her feel swollen, bloated, sluggish and uncomfortable. Only by taking birth control pills or female period inducing hormone could she have normal periods. At the time of her next period, she was able to have a two-day flow with relief.

### EXAMPLE 4

A 50 years old female had low chronic back pain for years. After exposure to the bible field, her low back soon felt significant relief. Checking with her a few days later, she was grateful that the relief was still present.

### EXAMPLE 5

A 75 year old Chinese male that is not a Christian, had injured his low back as a youth and was forced since to lean his upper torso slight forward since. Trying to straighten up erect quickly would tighten up his low back and eventually cause pain. After exposure to the cone for 30 minutes he immediately was able to easily straighten up and maintain an erect posture for hours. The next day he still could stand erect easily. I took this opportunity to get him to accept the Lord which he was very receptive.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A bible field enhancer, wherein the bible field enhancer enhances a bible field of a bible, comprising a receiver cone that is adapted to receive the bible field, wherein the receiver cone is hollow, and the apex of the cone is positioned near a bible.

2. The bible field enhancer of claim 1, further comprising a bible pedestal, and a bible placed on the pedestal, wherein the bible is open in the middle and closed over the top, wherein the apex of the receiver cone is projected about ⅔ way in the middle of the bible.

3. The bible field enhancer of claim 2, wherein the bible is Judeo-Christian bible with the old and new testaments written completely in the King James Version.

4. The bible field enhancer of claim 1, further comprising a bible jacket holder that is adapted to hold a partially opened bible, wherein the bible jacket holder is attached along the receiver cone.

5. The bible field enhancer of claim 4, wherein the receiver cone comprises a first cone segment, a second cone segment and a third cone segment, wherein the second cone segment overlaps with the first cone segment and the third segment at it ends.

6. The bible field enhancer of claim 5, wherein the bible jacket holder comprises three jacket holders that are attached to the three cone segments, respectively.

7. The bible field enhancer of claim 6, further comprising one or more bibles that are enclosed within the jacket holders.

8. The bible field enhancer of claim 7, wherein each of the jacket holders comprises a copper foil panel, and a plurality of gold leaves that are layered over the cooper foil panel.

9. The bible field enhancer of claim 8, wherein the bible comprises a Gideon bible with covers removed.

10. The bible field enhancer of claim 9, wherein each of the bibles is closed about 75%-80% with approximately 20%-25% open at the middle, page 647.

11. The bible field enhancer of claim 9, wherein the bibles are aligned so that they have the same orientation.

12. The bible field enhancer of claim 11, wherein the bibles contact outer surfaces of the cone segments.

13. The bible field enhancer of claim 12, wherein each of the bibles is Judeo-Christian bible with the old and new testaments written completely in original text or any accurate translation into any language.

14. The bible field enhancer of claim 5, wherein the cone segments are made of titanium.
